(19) United States
(12) Patent Application Publication
(10) Pub. No.: US 2009/0208342 A1
(43) Pub. Date: Aug. 20, 2009

(54) TURBOMACHINE PART HAVING ITS LEADING EDGE CONSTITUTED BY A SUPERELASTIC MATERIAL

(75) Inventor: Claude MONS, Savigny Le Temple (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 12/370,914

(22) Filed: Feb. 13, 2009

(30) Foreign Application Priority Data
Feb. 14, 2008 (FR) 0850935

(51) Int. Cl. F01D 5/28; F01D 9/00; B23P 15/02

(52) U.S. Cl. 416/241 R; 415/200; 29/889.7

(57) ABSTRACT

The invention relates to a turbomachine part comprising a main portion and a leading edge. Over at least a fraction of the length of said part, the leading edge is constituted by a sheet of material that is fastened to the main portion and that extends from the pressure side to the suction side of the main portion while leaving a space between the sheet and the upstream end of the main portion, said material being capable, below a maximum deformation ε₂, of responding to an impact against a foreign body by deforming reversibly in superelastic manner without damaging the main portion.

### FIELD OF THE INVENTION

The present invention relates to a turbomachine part comprising a main portion and a leading edge.

In the description below, terms such as “upstream” and “downstream” are defined relative to the normal flow direction of air along the part. The terms “length” and “height” designate respectively the greatest and the smallest dimensions of the part perpendicularly to the air flow direction.

The term “leading edge” is used of a part to mean the portion of the part that, in normal operation while subjected to a stream of air, is the portion that is impacted directly by said stream. The leading edge is thus the portion of the part that is furthest upstream. In a turbomachine, airfoils are an example of parts that are subjected to an air stream.

### BACKGROUND OF THE INVENTION

The air stream that flows around stationary or moving parts of a turbomachine may convey foreign bodies (gravel, pieces of ice, . . . ) that can impact against the parts at high speed and damage them. In particular, it is the leading edges of such parts that are subjected to impacts, and that therefore become deformed in undesirable manner. Such damage is particularly harmful for turbine airfoils, in particular the outlet guide vanes (OGV) and the inlet guide vanes (IGV) that participate in creating the thrust developed by the turbomachine. A collision with a foreign body can firstly affect the structural integrity of the airfoil (creating external or internal cracking, and delamination if the part is made of composite materials), thereby giving rise to a risk of the part breaking and causing severe damage to portions of the turbomachine downstream therefrom. Secondly, such a collision almost always deforms the leading edge of the airfoil, thereby causing its aerodynamic profile to depart from the ideal and disturbing the flow of air around said airfoil, and thus diminishing the performance of the turbomachine.

It is therefore essential to protect the leading edge of a turbomachine part from the impacts it might suffer against foreign bodies. Such protection is presently achieved by applying a metal layer on the leading edge of the part, which layer is made out of steel or titanium alloy and fits closely round the profile of the leading edge, being in contact therewith. The function of this layer is to absorb as much as possible of the energy of an impact against a foreign body so as to limit the damage suffered by the part. Nevertheless, in spite of this, the part still suffers damage as a result of repeated impacts, and the surface of the layer becomes deformed permanently, thereby harmfully modifying the aerodynamic profile of the part. Furthermore, a single impact can often have sufficient energy to deform the layer beyond its elastic limit (i.e. by causing it to deform by more than the maximum elastic deformation of the material, so the material is deformed in the plastic range in irreversible manner).

### OBJECT AND SUMMARY OF THE INVENTION

The present invention seeks to remedy these drawbacks, or at least to attenuate them.

The invention proposes a part that can return to its initial shape after an impact against a foreign body, so that the mechanical performance thereof is not affected by the impact.

This object is achieved by the leading edge being constituted over at least a fraction of the length of the part by a sheet of material that is fastened on the main portion and that extends from the pressure side to the suction side of the main portion while leaving a space between the sheet and the upstream end of the main portion, the material being capable, below a maximum deformation ε₂, of responding to an impact against a foreign body by deforming reversibly in superelastic manner without damaging the main portion.

By means of these dispositions, under the effect of an impact against a foreign body, the leading edge of the part deforms but without damaging the main portion of the part, i.e. its structural portion. Furthermore, because of the superelastic properties of the material constituting the leading edge, the leading edge is suitable for returning substantially to its initial shape as it was prior to impact, even after an impact of high energy.

For example, the superelastic material may be a shape memory alloy in its austenite phase.

Advantageously, above maximum deformation ε₂, the material is capable of returning to its shape prior to deformation by being heated to above a transition temperature Tₜ.

By means of these dispositions, even after being severely deformed (i.e. by more than the deformation ε₂) as a result of an impact, the leading edge is capable of returning substantially to its initial shape as it was prior to impact by heating the material constituting the leading edge to above a transition temperature.

The invention also provides a method of fabricating a turbomachine part comprising a main portion that has a leading edge.

According to the invention, the method comprises: truncating the leading edge of the main portion; fastening on the main portion a sheet of material that extends from the pressure side to the suction side of the main portion over at least a fraction of the length of the main portion, in such a manner that the sheet reconstitutes the profile of the leading edge of the main portion prior to the leading edge being truncated, the material being capable, below a maximum deformation ε₂, of responding to an impact against a foreign body by deforming reversibly in superelastic manner without damaging the main portion.

### BRIEF DESCRIPTION OF THE DRAWING

The invention can be well understood and its advantages appear better on reading the following detailed description of an embodiment given by way of non-limiting example. The description refers to the accompanying drawing, in which:

FIG. 1 is a perspective view of a segment of a prior art turbomachine airfoil;

FIG. 2 is a cross-section view of a turbomachine airfoil of the invention;

FIG. 3 is a cross-section view of another embodiment of a turbomachine airfoil of the invention; and

FIG. 4 is a plot of an example of a stress-deformation curve for a shape memory alloy.

### MORE DETAILED DESCRIPTION

The description below relates to the circumstances in which the part possessing a leading edge is an airfoil. For example the airfoil may be an outlet guide vane (OGV) or an inlet guide vane (IGV). Nevertheless, the invention applies to any turbomachine part that possesses a leading edge and that is subjected to a stream of air, such as for example an inlet arm of a casing.

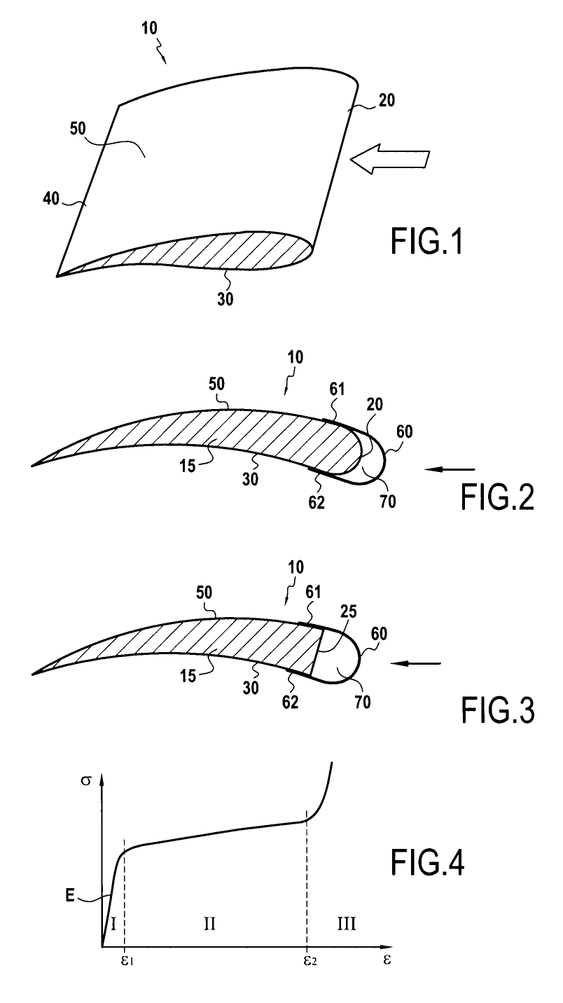

FIG. 1 shows a segment of a turbomachine airfoil 10. The airfoil 10 has an upstream end 20, a pressure side 30, a suction side 50, and a downstream end 40. The upstream end 20 is the portion of the airfoil that is the first to be encountered by the stream of air in normal operation of the turbomachine, and that thus constitutes the leading edge of the airfoil 10. In FIGS. 1 to 3, this air stream moves from right to left, as represented by an arrow. The pressure side 30 is the concave surface of the airfoil 10, i.e. the surface along which the stream of air flowing around the airfoil 10 generates extra pressure. The suction side 50 is the convex surface of the airfoil 10, i.e. the surface along which the stream of air generates suction. Thus, the airfoil 10 is substantially in the form of a curved plate of thickness that increases going from its downstream end 40 towards its upstream end 20.

FIG. 2 shows an airfoil 10 of the invention. The airfoil 10 comprises firstly a main portion 15 possessing an upstream end 20, a pressure side 30, a suction side 50, and a downstream end 40, and secondly a sheet 60. The main portion 15 is identical to the airfoil of FIG. 1. The upstream end 20 of the main portion 15 is covered by the sheet 60. The sheet 60 extends lengthwise in the direction D in which the upstream end 20 of the main portion 15 extends. The sheet extends width-wise in a plane that is perpendicular to said direction D (the direction D being perpendicular to the plane of FIG. 2). Thus, in this plane, the sheet extends from a first edge 61 to a second edge 62, each of these edges extending along the direction D. The first edge 61 is fastened all along its length (i.e. along the direction D) to the suction side 50 close to the upstream end 20, and the second end 62 is fastened all along its length to the pressure side 30, close to the upstream end 20. Thus, the sheet 60 is substantially U-shaped in a plane perpendicular to the direction D.

It is important that such fastening does not generate projections relative to the surface of the part so as to avoid disturbing the flow of air along the pressure side 30 and the suction side 50. Thus, fastening may be performed, for example: by adhesive; by brazing; by welding; or by riveting.

The upstream end 20 of the main portion is covered over its entire length (direction D) by the sheet 60. Alternatively, the sheet 60 may cover the upstream end 20 over only a fraction of its length.

The sheet 60 is made from a material that is superelastic, i.e. a material that is capable of returning to its initial shape once the stress to which it has been subjected is removed (reversible deformation), and that is capable of doing so for levels of deformation that are much greater than the levels of deformation that correspond to the usual elastic limit of alloys. Thus, for an ordinary alloy, the elastic limit, i.e. the stress up to which deformation is elastically reversible (conventional elasticity) is of the order of 0.1%. For a superelastic material, it is of the order of several percent.

For example, the superelastic material of the sheet 60 is a shape memory alloy. In shape memory alloys, the superelasticity is due to a reversible transformation of the austenite phase (face centered cubic crystal lattice) into the martensite phase (body centered tetragonal crystal lattice) at a temperature that is substantially constant. By way of example, shape memory alloys are alloys of copper-nickel (Cu—Ni), copper-zinc-nickel (Cu—Zn—Ni), or nickel-titanium (Ni—Ti, Nitinol®), possibly alloyed with other elements (iron, niobium).

FIG. 4 shows an example the stress-deformation curve for a shape memory alloy, this curve being written σ(ε). It should be observed that the curve has three regions: for deformation ε less than the minimum deformation ε₁ (region I), the material is linearly elastic (conventional elasticity); for deformation ε lying in the range ε₁ to maximum deformation ε₂ greater than the minimum deformation ε₁ (region II), the material is superelastic (it deforms quickly under stress that increases little); for deformation ε greater than the maximum deformation ε₂ (region III) , the deformation is not reversible. The region II constitutes the range in which deformation is superelastic. The maximum deformation ε₂ may for example lie in the range 3% to 10%.

Prior to applying a stress σ (i.e. before impact), the shape memory alloy constituting the sheet 60 is austenitic. The energy of an impact with a foreign body causes this alloy to transform metallurgically into martensite, and gives rise to reversible superelastic deformation of the sheet 60 (i.e. deformation lies in the deformation range [ε₁, ε₂]). After impact, the alloy thus returns to its initial shape (as it was prior to impact).

In order to accommodate the deformation of the sheet 60 that results from the impact, a space 70 is left between the sheet 60 and the upstream end 20 of the main portion 15, as shown in FIG. 2. The space 70 constitutes an empty cavity. Thus, the cavity 70 is of a size that is sufficient to enable the sheet 60 to deform without touching the upstream end 20 of the main portion 15, or if it does touch it, without causing damage thereto that would be harmful to the mechanical integrity of the main portion 15.

The crumple distance for the sheet 60 depends on the energy and the shape of the impacting projecting, on the thickness of the sheet, and on the size of the part. By way of example the crumple distance may lie in the range 0.1 millimeters (mm) to 0.5 mm. By way of example, the thickness of the sheet may lie in the range 0.1 mm to 0.5 mm.

In order to provide the cavity 70, the upstream end 20 of the main portion 15 may be truncated to form an upstream face 25 that is substantially plane. This embodiment is shown in FIG. 3. The sheet 60 can thus be fastened to the main portion 15 in such a manner as to reconstitute the profile of the upstream end 20 (leading edge) of the main portion 15 prior to said upstream end 20 being truncated. Thus, a part 10 is obtained having its leading edge constituted by a sheet 60 of superelastic material, with the shape and the volume of the part 10 being substantially identical to the initial shape and volume of the main portion 15 prior to having its upstream end 20 truncated. As a result, the aerodynamic characteristics of the part 10 are conserved.

Alternatively, the space 70 may be filled with a filler material of stiffness that is considerably less than the stiffness E₀ of the material of the main portion 15. This filler material (e.g. a solid foam) makes it easier to fasten the sheet 60 on the main portion 15, and provides the sheet 60 with mechanical support.

Advantageously, in the event of said material being subjected to deformation ε less than the minimum deformation ε₁ (region I), the stiffness E of the sheet material 60 is of the same order of magnitude as the stiffness E₀ of the material of the main portion 15. Consequently, the deformation ε of the sheet 60 remains within the elastic range I (deformation less than the minimum deformation ε₁) up to a higher stress σ, specifically a stress given by the equation σ₁=E×ε₁. Thus, the airfoil 10 can withstand, with hardly any deformation, greater-energy impacts with foreign bodies (i.e. up to impacts that generate stresses σ in the sheet 60 that are greater than σ₁), and the material of the sheet 60 enters the superelastic range II only for impacts of large energy (i.e. the range of deformations greater than the minimum deformation ε₁ and less than the maximum deformation ε₂). Thus, the sheet 60 will conserve for longer its ability to deform in superelastic manner. It is known that shape memory alloys age beyond some given number of superelastic deformation cycles, this aging giving rise to deterioration in the ability of such alloys to return to their initial shape after deformation.

The austenite-martensite transformation temperature of the shape memory alloy constituting the sheet 60 must be lower than the operating temperature range for the part 10 for which the sheet 60 constitutes the leading edge. Otherwise, the superelastic effect is disturbed (which effect is due solely to applying a mechanical stress), and the sheet 60 does not return to its initial shape as it was prior to impact. In this operating temperature range, the sheet 60 is therefore in the austenite phase. For so-called “cold” parts of a turbomachine, in particular parts that are upstream from the combustion chamber, this temperature range is typically −50° C. to 130° C.

It is possible that certain particularly high energy impacts (greater weight or speed of the foreign body) generate deformation ε₃ in certain zones of the sheet 60 that is greater than the maximum deformation ε₂ (region III). In such zones, the material suffers deformation that is not reversible in part, with the non-reversible deformation corresponding to |ε₃−ε₂|. With shape memory alloys, in such zones the energy of the impact causes the material to go from the austenite phase to the martensite phase and, after impact, the material therefore remains in the martensite phase. This remanent, non-reversible deformation can therefore be made reversible by heating the deformed zones to above the transition temperature Tₜ that constitutes the upper limit of the range of martensite to austenite transition temperatures for the shape memory alloy. The transition temperature Tₜ is an intrinsic characteristic of the shape memory alloy.

In general, the leading edge may be constituted by any superelastic material that, when subjected to deformation greater than the maximum deformation ε₂, is suitable for returning to its initial shape (prior to deformation) by being heated to above a transition temperature Tₜ.

What is claimed is:

1. A turbomachine part comprising a main portion and a leading edge, wherein said leading edge is constituted over at least a fraction of the length of said part by a sheet of material that is fastened on said main portion and that extends from the pressure side to the suction side of said main portion, while leaving a space between said sheet and the upstream end of said main portion, said material being capable, below a maximum deformation ε₂, of responding to an impact against a foreign body by deforming reversibly in superelastic manner without damaging the main portion.

2. A turbomachine part according to claim 1, wherein said material is a shape memory alloy in the austenite phase.

3. A turbomachine part according to claim 1, wherein the stiffness of said material is of the same order of magnitude as the stiffness of the material of said main portion when said material is subjected to deformation less than a minimum deformation ε₁, said minimum deformation ε₁ being less than the maximum deformation ε₂.

4. A turbomachine part according to claim 1, wherein said material is capable, above said maximum deformation ε₂, of returning to its shape prior to deformation by being heated to above a transition temperature Tₜ.

5. A turbomachine part according to claim 1, wherein said space constitutes an empty cavity.

6. A turbomachine part according to claim 1, wherein the upstream end of said main portion is a substantially plane upstream face.

7. A turbomachine part according to claim 1, wherein said sheet covers the upstream end of said main portion over its entire length.

8. A turbomachine part according to claim 1, wherein said part is an airfoil.

9. A turbomachine including a part according to claim 1.

10. A method of fabricating a turbomachine part comprising a main portion having a leading edge, wherein the method comprises: truncating the leading edge of said main portion; fastening on said main portion a sheet of material that extends from the pressure side to the suction side of said main portion over at least a fraction of the length of said main portion, in such a manner that said sheet reconstitutes the profile of the leading edge of said main portion prior to said leading edge being truncated, said material being capable, below a maximum deformation ε₂, of responding to an impact against a foreign body by deforming reversibly in superelastic manner without damaging the main portion.
